(19) United States
(12) Patent Application Publication
(10) Pub. No.: US 2005/0069635 A1
(43) Pub. Date: Mar. 31, 2005

(54) Machine for the production and/or converting of a material web and methods for removing contaminations in regard to such machinery

(76) Inventors: Ingo Becker, Koln (DE); Horst Kaipf, Lauingen (DE); Manfred Ueberschar, Gerstetten (DE); Werner Buttschardt, Herbrechtingen (DE); Klaus Meier, Hundersingen (DE); Ingo Gottwald, Steinheim (DE); Josef Janzer, Gerstetten (DE)

Correspondence Address: Todd T. Taylor;Taylor & Aust, P.C., 142 S. Main Street, P.O. Box 560, Avilla, IN, 46710, US

(21) Appl. No.: 10/902,355

(22) Filed: Jul. 29, 2004

Related U.S. Application Data
(63) Continuation of application No. PCT/EP03/00898, filed on Jan. 29, 2003.

(30) Foreign Application Priority Data
Jan. 29, 2002 (DE) 102 03 550.4
Oct. 23, 2002 (DE) 102 49 395.2

(51) Int. Cl. B05C 11/00

(52) U.S. Cl. 427/154; 118/504; 118/45

(57) ABSTRACT

A machine for the production and/or converting of a material web, especially a paper or carton web, such as a coating machine for single sided or two-sided application of liquid or viscid coating medium onto a moving web by way of at least one application device. At least one carrier surface, or partial surface, and/or at least one area or partial area, of the machine that is exposed, or could be exposed, during the operation and/or during start-up of the machine and/or during slow-down of the machine and/or during at least an exceptional operational condition of the machine to the medium is a focus of the present invention. Application medium, that is used in the production or converting process, and/or is subjected to another contamination hazard, is formed by or furnished with a permanent or temporary, protective layer, also referred to as barrier layer, that is applied to the carrier surface. The protective layer possesses anti-adhesive properties with regard to the medium or contaminating materials and/or is removable, together with the adhering medium or contaminating material.

### CROSS REFERENCE TO RELATED APPLICATIONS

This is a continuation of PCT application No. PCT/EP03/00898, entitled “MACHINE FOR THE PRODUCTION AND/OR CONVERSION OF A SHEET OF MATERIAL AND METHODS RELATING TO SUCH A MACHINE, PREVENTING IMPURITIES OR FACILITATING REMOVAL THEREOF”, filed Jan. 29, 2003.

### BACKGROUND OF THE INVENTION

1. Field of the Invention

The invention relates to a machine for the production and/or converting of a material web, especially a paper or cardboard web, and, more particularly, a coating machine.

2. Description of the Related Art

Surfaces of coating machines are contaminated during coating of the material web by splashing ink particles and separated fiber particles and other particles that generally adhere to the carrier surfaces of the machine.

When these areas, especially the surface areas, come in contact with the warm or hot coating ink and the ambient air, the ink particles dry quickly and form deposits. During the further progression of the coating process of the web, these deposits build up and may form “clods”. These clods can crumble and drop onto the freshly coated web, thereby negatively influencing the coating result. They may even cause a break of the moving web, resulting in considerable downtime of the equipment. Such clods will also deposit themselves at or in the applicator nozzles, thereby causing obstructions that negatively affect the coating result.

In order to reduce or prevent the adherence and caking of this type of contamination the affected surfaces are customarily sprayed with water, thereby softening and/or diluting the crusting. Certain surfaces, such as the nozzle lips of an open jet nozzle are also cooled, whereby the condensate that forms assists in the dilution and prevention of ink particle caking.

In this context we refer to the following publications:
German Patents, DE 34 04 706 in which a coating deckle is disclosed that is equipped with channels, and through which adhering clumps of coating medium are flushed out by way of a special cleaning liquid.
DE 296 17 829 in which a vibration element is disclosed, that is located in the area between a doctor element and the baffle plate of a coating device and which is intended to prevent caking on the baffle plate due to oscillations.
DE 198 01 140 in which a method is suggested according to which the jet opening on an open jet nozzle is kept clear by regulating the feed stream of the application medium or an other parameter of the application medium.
DE 198 14 491 in which the feasibility of spraying a cleaning liquid directly into the metering gap leading to the nozzle discharge opening, is disclosed.
DE 198 14 490 where a solution is suggested that provides for mechanical removal of the obstruction of the discharge opening.
DE 101 18 631 where a solution is suggested according to which a cooling channel is incorporated into one or both nozzle lips of an open jet nozzle.

All aforementioned solutions are relatively time consuming and expensive. Many times, the intervals at which cleaning must occur, are very short. Usually the machine must be shut down to perform this task. Since clean-up is often very involved, the machine down time is usually long and the conventional solutions are therefore very inefficient.

What is needed in the art is a cost effective approach to reduce or eliminate contamination.

### SUMMARY OF THE INVENTION

It is the objective of the present invention to cite constructional and/or methodological measures in a comparison as to how contamination can be avoided cost effectively, or can at least be reduced, or can be removed more easily.

In order to meet this objective, the present invention relates to a machine for the production and/or converting of a material web, especially a paper or carton web. Possibly a coating machine for single sided or two-sided application of liquid or viscid coating medium onto a moving web by way of at least one application device. At least one carrier surface, or partial surface, and/or at least one area or partial area, of the machine that is exposed, or could be exposed, during the operation and/or during start-up of the machine and/or during slow-down of the machine and/or during at least an exceptional operational condition of the machine to the medium is a focus of the present invention. Application medium that is used in the production or converting process, and/or is subjected to another contamination hazard, is formed by or furnished with a permanent or temporary, (solid if desired), protective layer, also referred to as barrier layer, that is applied to the carrier surface. The protective layer possesses anti-adhesive properties with regard to the medium or contaminating materials and/or is removable, if necessary, together with the adhering medium or contaminating material.

By the provision of a protective layer, that offers anti-adhesive characteristics, contact between a respective exposed surface of a respective machine component and contaminating medium, especially coating medium, can be prevented. The anti-adhesive characteristics ensure that the contaminating mediums adhere ‘at most’ only slightly to the protective layer, so that no clean-up is necessary, or that clean-up is considerably easier. The protective layer may be homogenously conjoined with the surface of the respective carrier, for example stainless steel or carbon fiber laminate, and will then not be replaced over the lifetime of the component. The protective layer can be an integral part of the component and, because of the anti-adhesive characteristics, prevent a homogenous joining with deposits or contaminations. The surface properties of the original carrier surface are fundamentally altered by this, to the extent that contaminations will no longer adhere, or at most adhere only very ineffectively.

In place of, or preferably in addition to the anti-adhesive properties, the protective layer may be applied so as to be temporary and, if desired, be removed comparatively easily, along with the adhering contaminating material. For this purpose the protective layer can be conjoined as a functional layer with the surface of a carrier or a similar device made mostly of stainless steel or carbon fiber laminate. Additionally, the protective layer may perform a separation function as it lies between contaminating mediums on the one hand, and the surface or partial surface on the other hand. The protective layer can be easily removed after a certain period of time, for example, after one day, a month, or half a year. In as far as contaminations adhere on a protective layer, they are easily removable together with the protective layer, since there is no contact with the surface or partial surface of the machine that is protected by the protective layer.

Additionally, the present invention also relates to a method for the treatment of a carrier surface in a machine for the production and/or converting of a material web, especially a paper or cardboard web, such as a coating machine. The coating machine affords for single sided or two-sided application of liquid or viscid coating medium onto the moving material web by means of at least one application device. A protective layer is applied to the carrier surface that, during operation and/or during start-up of the machine and/or during slow-down of the machine and/or during at least an exceptional operational condition of the machine is exposed or could be exposed to the medium, possibly a coating medium that is used in the production or converting process and/or is subjected to other contamination hazards. The principal objective regarding the protective layer in this connection is, that the protective layer possesses anti-adhesive properties with regard to the medium or the contaminating materials and/or can be removed together with the adhering medium or contaminating material.

The protective layer may, advantageously, be formed from a hydrophobic, that is a water repellent protective coating material. Surfaces that are equipped with a hydrophobic, having a non-moistening effect, coating of this type, perhaps in the form of a coat of paint, cause mediums that tend to adhere, predominantly ink particles from the machine, and other contaminants, will easily bead off of the carrier surfaces, so that no contaminant deposits or caking forms for extended time periods. Clean-up cycles are thereby greatly extended. The machine has to be shut down less frequently, thus reducing detrimental and cost intensive downtimes. The less frequently required clean up is also accomplished much more easily. An additional advantage is that there are fewer web breaks, caused by dropping clods.

The protective coating material has contaminant repelling and/or electrostatic repelling characteristics. This allows the clean-up intervals to be deferred for especially long time periods.

The protective layer can be formed as a PTFE (Teflon™ or polytetrafluoroethylene) and/or a fluorine containing protective layer, and/or may have anti-adhesive properties based on the lotus blossom effect.

The protective layer is installed primarily on carrier surfaces in machines of the aforementioned type, especially coating machines where the susceptibility to contamination is especially high. The protective layer is applied especially on internal and/or external carrier surfaces of machine components, such as interior and exterior walls of a discharge opening of an applicator nozzle, of guide surfaces, of ink distributor pipes, of an ink pan, etc., especially interior and/or exterior carrier surfaces of an applicator device in the machine. In general, at least one metallic surface is or will be equipped with the protective layer. Obviously, such a protective layer may be utilized in applicator devices of various types, as well as in other areas of the machine. Therefore, the protective layer is also applied to surfaces of a film press and/or a coating unit having a long coating medium reaction time (LDTA) and/or a coating unit having short coating medium reaction time (SDTA) and/or a coating unit with a pressure type open jet nozzle and/or a coating unit for curtain coating.

The protective layer is applied as a permanent and/or integral part of a machinery component. The protective layer is joined permanently with the surface of the carrier surface in the machine, so that the protective layer will not have to be replaced during the life span of the respective component. The protective layer can be “designed into” the component from the outset. Another aspect of the present invention is to provide a component, such as a plate type component on the carrier surface that forms the protective layer.

The protective layer prevents a solid adherence of the deposit to, or contamination of, the carrier surface by altering the surface characteristics of the original carrier surface to such an extent, that contaminations no longer adhere to the surface. Bonding of the protective layer with the carrier surface of the machinery component may be achieved advantageously by adhesive forces, for example through the utilization of glue.

The protective layer is on, or can be applied to, the carrier in the form of paint or lacquer, especially by brushing or spraying it on. The protective layer is applied through spraying or steam, or in a condition other than that of the finished protective layer, whereby the protective layer hardens on the carrier surface of the machinery component.

The protective layer is applied to polished, cleaned or already painted metallic surfaces. It is applied, for example, at a thickness of 40 to 200 μm. A polished protective layer may be provided. In the example of a painted protective layer the layer can be polished after approximately 1 to 5 hours, depending upon whether hot air is used for drying.

Furthermore, the protective layer may include a flexible sheet type material, possibly a flexible material such as a film, or web material. This sheet type material can be shrunk, under the influence of temperature, whereby the protective layer adapts even to complicated surface geometries. The protective layer is held on the carrier surface by mechanical tension forces. Alternatively, the protective layer can be glued to the carrier surface of the machine.

According to another embodiment of the present invention, the protective layer is a multi-layer arrangement whereby at least one top layer of the multi-layer protective layer is applied to be temporary and can be removed without causing damage to the layer beneath it. The top layer can be removed either with the objective of subsequently renewing the removed layer or, preferably, so that the layer or layers beneath it will then form the protective layer. The number of layers can be calculated to be sufficient for the entire lifespan of the component. However, when the last layer has been removed, a new multi-layer protective coating can be installed. Preferably, the temporary protective layer, or at least the removable top layer is more flexible than the carrier surface.

For retrofitting an existing machine according to the present invention it is particularly advantageous to spray or steam the protective layer on, and to harden it on the carrier surface of the machinery component. Another possibility is to glue the protective layer on. There is also the already discussed feasibility of shrink applying the protective layer. A particularly useful variation is to paint the protective layer on, preferably in the form of a lacquer, a paint or a paste. This type of application is easily accomplished. The hydrophobic coating material can be applied to a polished, cleaned and also to an already painted surface, such as metallic surfaces. As previously mentioned the protective coating material is dirt repellent and/or possess electrostatic repellent properties in order to greatly extent the clean-up intervals.

The coating material to be used may, for example, be Teflon (PTFE, that is, polytetrafluoroethylene) or a fluorine containing medium, in the form of paste or lacquer. The method can also be utilized in other areas of a machine for the production and/or converting of a material web, especially a fibrous web, than those previously discussed where contaminations other than those hitherto discussed, occur. Application of the method will be especially appropriate on surfaces in coating machines, since the contamination susceptibility is particularly high. Surfaces to be treated include guide surfaces inside and outside the coater, interior and exterior walls of the discharge opening of applicator nozzles, metering gaps, ink distributor pips as well as ink pans in the coater.

The protective layer is such that it can be easily removed after a certain functional period, for example a day, a month or half a year. Contaminants are removed together with the protective layer. Removal of the protective layer may, for example, be accomplished through utilization of a solvent and/or setting of a certain removal temperature. In a multi-layer arrangement the top layer can simply be pulled off.

Another embodiment of the present invention includes a method for servicing and/or clean-up of a machine as described above for the production and/or converting of a material web, especially a paper or cardboard web. The machine being a coater for single or two-sided application of a liquid or viscid coating medium onto a moving material web by way of at least one applicator device. At least one surface or partial surface and/or at least one area or partial area of the machine that is exposed to the medium, that is used in the production or converting process and/or is subjected to another contamination hazard, has a temporary protective layer that is applied to a carrier surface. The method includes the step of a protective layer that is removed together with the adhering medium or contaminating material.

Thought is also given with regard to the suggested servicing/clean-up procedure, that the protective layer has an anti-adhesive property relative to the medium and contaminating material. The method may append to the treatment of a carrier surface, or may be the entire method. The created protective layer will, as a rule, be renewed. The protective layer can be removed by utilizing a solvent and/or setting of a particular removal temperature. A multi-layer protective layer is advantageously provided whereby at least the top layer is applied to be temporary and whereby the top layer is removed, either for subsequent renewal of the protective layer or so that the layer or layers beneath it will then form the protective layer.

According to another embodiment of the present invention is a machine for the production and/or converting of a material web, especially a paper or cardboard web, possibly a coating machine for single or two-sided application of a liquid or viscid coating medium onto a moving web by way of at least one application device. At least one surface or partial surface and/or at least one area or partial area of the machine that is exposed to the medium. The exposure may occur during operation and/or start-up of the machine and/or during slow-down of the machine and/or during at least an exceptional operational condition of the machine. The surface of the production or converting process, that is subjected to another contamination hazard can be furnished at least for the operation with a protective layer on the basis that a protective medium is furnished or applied by way of a feed or applicator device and forms the protective layer on the surface, or partial surface, or in the area, or partial area, and is removable and/or is continuously renewable during operation.

According to another embodiment of the present invention it is, for example, feasible to provide a barrier layer that does not become completely solid even during operation. The barrier layer can, for example, be sprayed on or steamed on prior to operation, whereby it preferably distributes itself very smoothly on the carrier surface. Contaminations and possibly the coating medium will therefore not come into contact with the carrier surface. If desired, the barrier layer can be removed relatively easily from the carrier surface after use. Possible contamination is then removed at the same time. Another feasibility exists in that the barrier layer or protective layer renews itself constantly during operation, whereby the renewal can advantageously and imperatively include removal of contamination.

The present invention further relates to a method for the protection of a carrier surface and/or an area or partial area in a machine, for example an inventive machine, as discussed above, for the production and/or converting of a material web, especially a paper or cardboard web. The machine being a coating machine for single or two-sided application of liquid or viscid coating medium onto a moving material web by way of at least one coating device. A protective layer is applied or provided for the protection of the carrier surface or the area or partial area, at least for the duration of the operation. The protective layer is formed by a protective medium that is supplied or applied by a feed or application device to a surface or partial surface of the machine. The surface is exposed, or could be exposed, during operation and/or start-up of the machine and/or during slow-down of the machine and/or during at least an exceptional operational condition of the machine to the medium. The medium, being possibly a coating medium, that is used in the production or converting process and/or that is subjected to another contamination hazard.

Yet another embodiment of the present invention provides a method for servicing and clean-up of a machine. The machine being for the production and/or converting of a material web, especially a paper or cardboard web. The machine being a coating machine for single or two-sided application of liquid or viscid coating medium onto a moving material web by way of at least one coating device. Here, the protective layer is removed and/or continuously renewed during operation from at least one surface or partial surface and/or from at least one area or partial area of the machine. The machine is exposed, or could be exposed, during operation and/or during start-up of the machine and/or during slow-down of the machine and/or during at least an exceptional operational condition of the machine to the medium. The medium being a coating medium that is used in the production or converting process and/or is subjected to another contamination hazard. The surface is furnished, at least for the operation, with a protective layer on the basis that a protective medium that forms the protective layer on the surface or partial surface is being supplied by way of a feed device.

The method for servicing and clean-up of the machine can append to an execution of the method for the protection of the carrier surface in the machine, or may comprise the method itself. In particular, following removal of the protective layer, the protective medium can be re-applied for the purpose of protecting the carrier surface and forming the protective layer on the carrier surface. The inventive removal and inventive re-application of the protective layer is part of an automatic servicing sequence for the allocated machine, whereby the removal of the protective layer may include cleaning of the respective component. Cleaning of the respective component may be carried out following removal of the protective layer and prior to the application of a new protective layer.

The protective layer can, for example, also consist of a liquid or highly viscous or non-rigid solid material. The protective layer is preferably hydrophobic and/or possesses contamination resistant and/or electrostatic resistant characteristics.

The protective layer can be provided on carrier surfaces of machinery components, such as interior and exterior walls on a discharge opening of an applicator jet, of guide surfaces, of ink distributor pipes, of an ink pan, etc., especially inside and/or outside carrier surfaces of an applicator unit in the machine. At least one metallic surface is to be provided with the protective layer. The protective layer can, for example, be provided to a surface of a film press and/or a coating unit having a long coating medium reaction time (LTDA) and/or a coating unit having a short coating medium reaction time (SDTA) and/or a coating unit with a pressure type open jet nozzle and/or a coating unit for curtain coating.

The protective layer can, for example, be sprayed on, or steamed on by way of a feed or applicator device, preferably so that it distributes itself very smoothly across the carrier surface. As a result of the protective layer being in place contamination and the coating medium will not come into contact with the carrier surface. The protective layer can, for example, be applied by spray nozzles that are mounted on the machine. Alternatively, the protective layer can also be painted onto the respective carrier surfaces in the machine by way of a suitable application device. An oil based, grease based, wax based, paraffin based, etc. protective layer can, for example, be provided. Basically, application of oil or grease on the respective surface is feasible.

Preferably, the protective layer will not be removed or dissolved by the coating medium. However, smaller amounts of the protective layer that could separate during operation will not necessarily influence the coating medium and the coating process negatively. In consideration of the environment the protective layer medium can advantageously be biologically degradable.

If the protective layer is to be removed, this can be achieved, for example, by setting the temperature to a degree that does not normally occur in normal operation, whereby the temperature would preferably be higher than 60° or lower than 20°. In addition, or alternatively, the protective layer can also be dissolved by an allocated solvent that is not contained in the coating medium.

The protective layer may also take the form of a protective layer that constantly renews itself during operation. To this end a flowing barrier can advantageously be produced that keeps contamination away from the surface of the machinery component and preferably transports it away from the surface. This liquid barrier consists preferably of water. A solvent should at least be provided, by means of which the coating medium is dissolvable. The protective layer therefore also has a cleaning function, in addition to the protective function. Using water as a protective layer has the advantage that existing recycling circuits can be used.

The protective layer can, for example, be developed as a sheet-type water curtain that flows over the surface of the machinery component that is to be protected. The water curtain may, for example, be produced by a spray tube or slotted nozzle. This type of sheet water curtain is preferred on surfaces of components below or behind the coating unit, perhaps on the open jet nozzle, ink pan, troughs, etc.

The protective layer does not necessarily need to cover the entire surface. It could be sufficient if the protective layer were to cover a partial surface of a machinery surface. The provision of a flowing barrier or sheet type protective layer medium curtain, possibly a water curtain, is suitable, primarily in areas that are subject to higher contamination. The protective layer medium flow, possibly water flow, protects against contaminations that do not occur from the outside, but are already present, for example, contamination on the roll shell, or arise from the inside, for example, escaping mediums, such as coating ink. A special advantage of this flow is that it carries off the contaminants, thereby avoiding a normally typical accumulation or build-up of material.

A partial application of the protective or barrier layer is a consideration especially for areas of the machine that are allocated to the side edge of the material web. Deckle slides and coating deckles for example, can frequently not be completely sealed. Therefore, minute quantities of coating medium can escape at these locations. These small quantities dry particularly quickly, leading to a rapid build-up of detrimental deposits. These small quantities can be carried off by a protective or barrier layer of a flowing barrier layer medium, perhaps water. A build-up of coating ink or coating medium on the adjacent surfaces is thereby reliably avoided. Also, in other exposed areas a particularly effective protective or barrier layer can be produced locally or partially, by a separate flow, perhaps a water flow. The protective layer can also easily be produced or be producible in areas that are not accessible from the exterior, for example inside a sealed working chamber.

In accordance with the embodiments of the present invention, the solutions greatly assist in avoiding down-times and subsequently, production losses due to web breaks. Conventional web breaks occur due to dirt accumulation in the machine, especially in the edge areas due to dirt from the base paper, due to deposits of coating medium on the machinery components (i.e. the air bars on the flotation dryers) and due to reject paper shreds. The aforementioned accumulations also lead to other types of malfunctions, resulting in a machinery stop.

In the event of heavy and/or persistent dirt accumulations and due to long set-up times associated with clean-up, such web breaks and machine stops can lead to extended down-times with high outage losses. Due to insufficiently cleaned components other delays, especially erection and start-up delays are to be expected.

In contrast, the present invention permits a clear improvement of the operating time efficiency or performance. Among other factors, this is due to avoidance of unintentional web breaks that are due to dirt build up, avoidance of other types of machine stops or at least a reduction in their frequency, due to shortening the down time during a stop and due to acceleration of the erection and restarting. These advantages are achieved through an effective control of contamination according to the various methods of the present invention. In one example, the build up of dirt is avoided or reduced, thereby extending the running time prior to the next stop considerably, and also increasing the operating time efficiency. Among other measures, cleaning during operation is suggested. Further, according to another variation the downtime is greatly reduced, thereby also increasing the operating time efficiency considerably. In addition, clean-up with, or on the basis of a protective layer or barrier layer according to the invention is more efficient than a conventional clean-up, whereby the reliability against malfunctions is additionally increased.

The invention in its various aspects and variations relates, in principle, to any given surface, partial surface, area and partial area, element and partial elements in a machine of the described type. Particular portions of the machine to which the invention is applied include the headbox for the production of a material web, especially also the surfaces and elements that are in contact with the stock suspension flow, from which the material web is formed, and also the nozzle discharge area. Additional portions of the machine include the dewatering elements that are effective during the material web formation, so that formation malfunctions during extended machine operation are avoided.

It is pointed out that, when either surface or partial surface is referred to this does not necessarily refer to a plane or flat “surface”. Any body that is exposed in at least some areas, any element that is exposed in at least some areas and any section of a machine that is exposed in at least some areas, has at least one surface or partial surface (possibly inside or outside surface, possibly inside circumferential surface or outside circumferential surface) for which a protection in accordance with the invention could be considered. The previous and below specifically referred to machine areas, machine partial areas, machine surfaces, machine partial surfaces, machine sections and machine partial sections are merely examples of a non-limiting character. However, they also provide a concrete preferred application possibility according to the present invention.

Within the scope of the invention kerosene may especially also be used advantageously as a liquid barrier layer medium.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic drawing of one embodiment of a coating machine and serves to explain a preferred application of an embodiment of the method of the present invention;

FIG. 2a is a schematic depiction of one design variation of the machine of FIG. 1;

FIG. 2b illustrates a layer construction of protective layer A, according to intersection line B-B in FIG. 2a;

FIG. 3 shows a schematic depiction of additional variations of the machine of FIG. 1; and

FIG. 4 shows a schematic depiction of additional variations of the machine of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

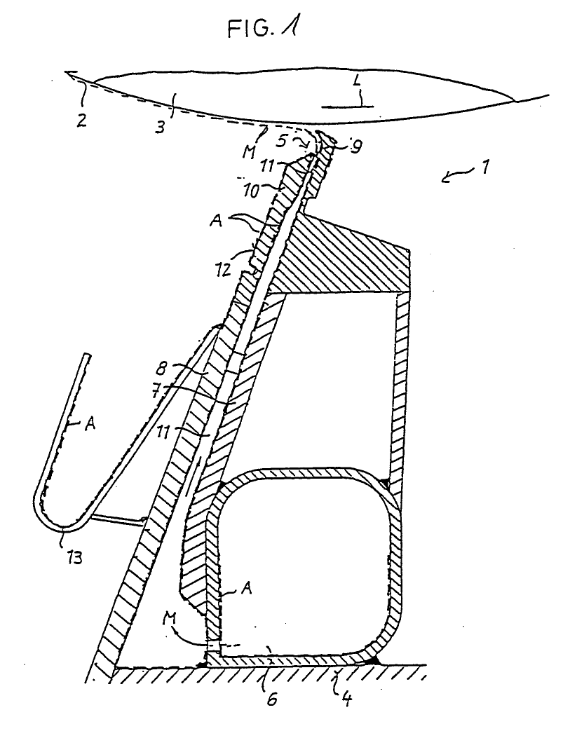

Referring now to the drawings, and, more particularly to FIG. 1 there is illustrated a so-called open jet nozzle coater 1. Coating unit 1 serves to coat a moving paper web 2 that runs around a support roll 3, with a coating medium M, for example, a pigmented coating ink M. The direction of travel of roll 3 and web 2 is indicated by an arrow L.

Coating unit 1 includes a support beam 4 that supports the individual elements of an applicator nozzle 5. Support beam 4 also includes a distributor pipe through which liquid or viscid coating medium M is supplied to nozzle 5.

On its top side, support beam 4 has a back wall 7 that progresses approximately radially to roll 3, and a front wall 8 that is located parallel to back wall 7, which respectively graduates into nozzle lips 9 and 10, or that are placed upon nozzle lips 9 and 10. Between front wall 8 with nozzle lip 10 and back wall 7 with nozzle lip 9 there is a supply gap 11. Supply gap 11 forms the outlet or application nozzle 5 in the area of nozzle lips 9 and 10, from which medium M is applied to the moving paper web 2. On the outside of wall 8 an overflow surface 12 is illustrated that flows into an excess collecting channel 13. From collecting channel 13 the excess medium may be discharged or, if desired, recycled to coater 1, following an appropriate cleaning and deaeration process.

In order that the approximately 60° C. warm coating medium does not adhere, or adhere for long, to the metallic coater parts, and in association with the ambient air, continues to build up further in those locations, applicator nozzle 5, feed gap 11, distributor pipe 6, the outside surface of nozzle lips 9 and 10, overflow surface 12 and also collecting channel 13 are provided with a protective layer that offers anti-adhesive properties with regard to the coating medium. In the aforementioned example the cited components and surfaces are provided with a hydrophobic coating. This protective layer, or coating, is indicated by a heavily drawn, dashed line A.

The protective coating material that forms protective layer A can be applied in a thickness of 40 to 200 μm and may be polished after a drying time of 1 to 5 hours, depending on whether or not hot air is used for drying, thereby improving the beading characteristics.

The hydrophobic coating material A, which may be a Teflon or fluorinated latex paint, also contains agents for dirt resistance and/or electrostatic repellant. This permits an extension of the time for cleanup of the treated surfaces.

Based on the inventive protective coating, the cooling channels that are integrated into nozzle lips 9 and 10, for the purpose of routing through a cooling liquid, and which are known from the state of the art, as well as the associated expenditure for the cooling circuit are no longer necessary.

A coat of paint, similar to the example, may also be utilized advantageously on other coating units or other areas of a coater. The coater being generally a machine for the production and/or converting of a material web, especially a fibrous material, especially paper or cardboard. For example, surfaces of a film press, a coating unit having a long coating medium reaction time (LDTA), a coating unit having a short coating medium reaction time (SDTA) or coating unit for curtain coating that are supplied with coating medium can be equipped with a protective coating, such as a coat of paint, according to the present invention.

It can be provided that the protective layer or the coat of paint A is removable, through a suitable solvent and perhaps to remove dirt residue that is adhering to the protective layer. These considerations are mainly directed to surfaces that are accessible from the outside, such as overflow surface 12 and collecting channel 13.

The protective layer may also be installed permanently, possibly as surfacing, as an integral part of the respective component. A permanent protective coating is useful, especially for surfaces that are not accessible from the outside, such as the inside surface of wall components 7 and 8 that are located next to feed gap 11.

There are many characteristics that the protective layer may advantageously possess, and many ways in which the protective layer can be applied or installed.

Protective layer A may, for example, possess generally dirt repelling and/or electrostatic repelling characteristics. Protective layer A may, for example, possess anti-adhesive characteristics that are based on the lotus blossom effect.

Protective layer A could, for example, also be sprayed on. Additionally, a flexible sheet type material, for example, a film may be glued onto the carrier surface, or shrink fitted to it. Alternatively, protective layer A can be in the embodiment of a plate component.

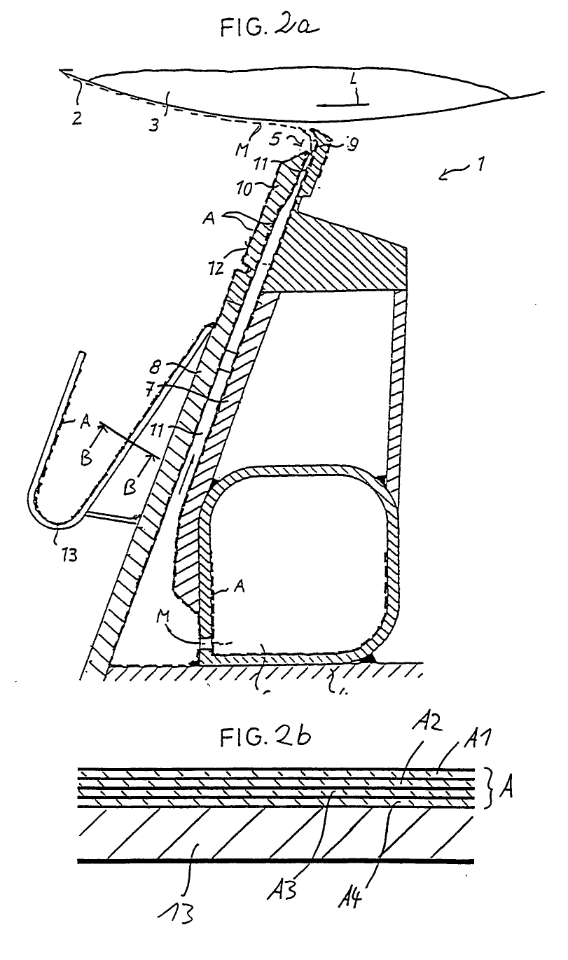

Now, additionally referring to FIGS. 2a and 2b there is illustrated a variation of the present invention. Only the differences compared to previously described design examples will be discussed. Matching references are used for identical or analogous components.

A particularly useful method of applying a protective layer is to glue the protective layer onto a surface that is to be protected, whereby preferably removal of the protective layer is accomplished in order to be able to remove contaminants that adhere to the protective layer, together with the protective layer. To this extent the protective layer installation is only temporary.

As illustrated in FIG. 2b, protective layer A includes multiple layers A1, A2, A3 and A4, whereby top layer A1 can always be removed without damaging the layers beneath it so that subsequent layer A2 is exposed and forms the surface of the protective layer. When the last layer is removed a new multi-layer protective layer can be applied, for example, glued, to the respective machinery surface. Instead of using separate glue, the protective layer or layers can be self-adhesive, thereby greatly simplifying the renewal of the protective layer. Suitable adhesives or glues that permit a removable installation of a protective coating or protective coating layer are available.

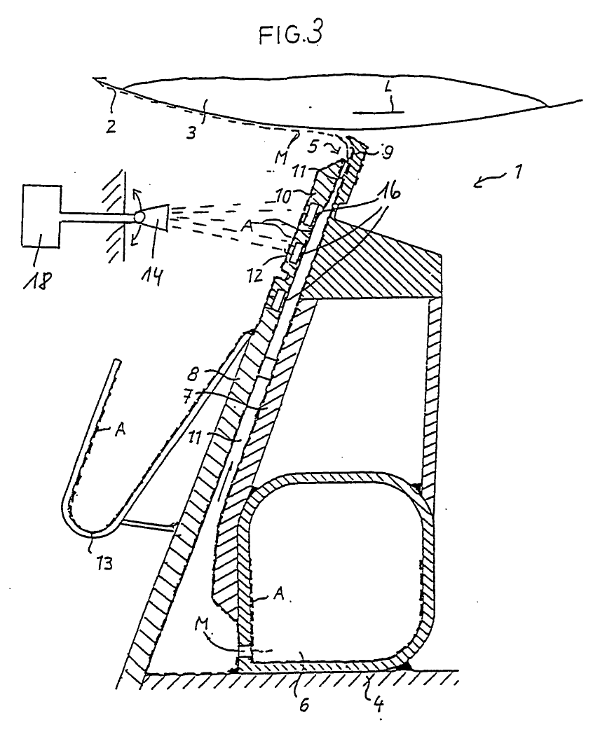

Now, additionally referring to FIG. 3 there is illustrated an additional embodiment of the machine according to the present invention. A spray nozzle arrangement 14 is mounted on the machine to ensure that a fine film, for example, oil is applied as a protective layer A to the carrier surfaces of the machinery component, in this example to overflow surface 12 and the surface of channel 13. Allocated container 18 contains and supplies the protective layer medium. A respective spray nozzle in spray nozzle arrangement 14 is pivoted or movable in order to be able to apply a protective layer A to as large an area as possible in the machine that could come into contact with the coating medium. Spray nozzle arrangement 14 can again be used to remove the applied protective film, possibly together with adhering dirt particles, by using a solvent. An additional, non-illustrated reservoir for the solvent may be connected with spray nozzle arrangement 14 through a selector valve.

Additionally, nozzle lips 10 may be equipped with a heating element 16 in order to effect or support the removal of protective layer A through a temperature increase. If removal by way of a solvent is provided for, a heating ability for the solvent is useful, for example a heated reservoir.

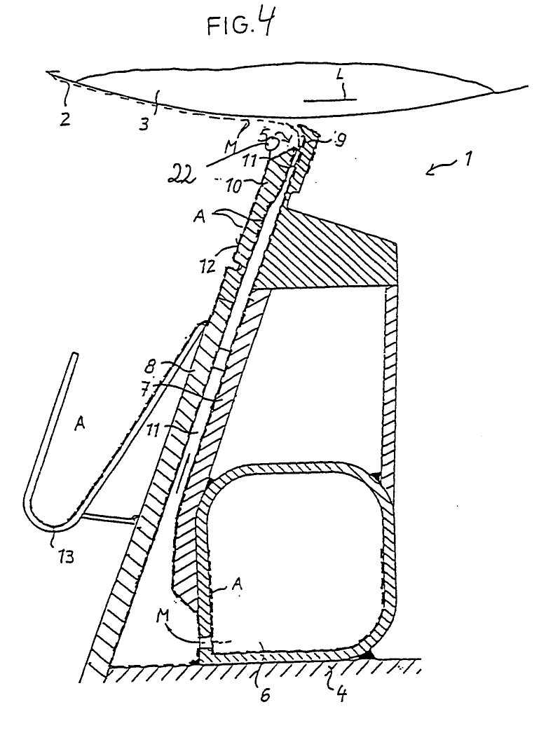

Now, additionally referring to FIG. 4 there is illustrated an additional embodiment of the machine according to the present invention. In FIG. 4 a spray pipe 22 is installed at the machine in close vicinity to the outlet or applicator nozzle 5, by which a flowing barrier A may be produced. Flowing barrier A, for example water, flows over an edge surface adjacent to nozzle 5, as well as over overflow surface 12, thereby carries coating medium splashes and other contaminating substances with it into excess collecting channel 13. A contamination of the aforementioned surfaces during operation is then prevented right from the outset. In the event that deposits or contaminations did form on the surfaces, these will be removed by the water and transported into excess collecting channel 13. The advantage of this embodiment is that contamination of the aforementioned surfaces is avoided from the outset, or that a clean-up occurs during operation. The running period until the next down-time of the machine is therefore greatly extended.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A coater machine for application of a coating medium onto a moving material web by way of at least one application device, comprising:
a machinery component having at least one surface; and
one of a permanent and a temporary protective layer applied during one of operation, start-up, slow-down and an exceptional operational condition of the machine, said at least one surface being exposable to at least one of the coating medium and contamination hazards, said protective layer possessing anti-adhesive properties with regard to the coating medium applied to said at least one surface, said temporary protective layer being removable together with said contamination hazards and the coating medium adhering to said protective layer.

2. The machine of claim 1, wherein said protective layer is hydrophobic.

3. The machine of claim 1, wherein said protective layer possesses at least one of a dirt repellent and an electrostatic repellent characteristic.

4. The machine of claim 1, wherein said protective layer is formed as one of a PTFE (Teflon) protective layer, a fluorine containing protective layer and a layer possessing anti-adhesive properties based on the lotus blossom effect.

5. The machine of claim 1, wherein said at least one surface includes at least one of an internal carrier surface, an external carrier surface, an interior wall of a discharge opening of an applicator nozzle, an exterior wall of a discharge opening of an applicator nozzle, of a guide surface, ink distributor pipes and an ink pan.

6. The machine of claim 1, wherein said at least one surface is a metallic surface equipped with said protective layer.

7. The machine of claim 1, wherein said at least one surface is included in at least one of a film press, a coating unit having a long coating medium reaction time (LTDA), a coating unit having a short coating medium reaction time (SDTA), a coating unit with a pressure type open jet nozzle and a coating unit for curtain coating.

8. The machine of claim 1, wherein said protective layer is one of permanent and integral to said machinery component.

9. The machine of claim 1, wherein said protective layer is applied to said at least one surface by one of brushing and spraying, said protective layer being one of a paint and a lacquer.

10. The machine of claim 1, wherein said protective layer is one of sprayed on, steam-applied, and is applied in a condition other than that of a finished protective layer.

11. The machine of claim 1, wherein said protective layer is applied with a thickness of between approximately 40 μm to 200 μm.

12. The machine of claim 1, wherein said protective layer is a component.

13. The machine of claim 12, wherein said component is a plate-like component.

14. The machine of claim 1, wherein said protective layer is a flexible sheet type material.

15. The machine of claim 14, wherein said flexible sheet type material is an elastic material in the form of a film of web type material.

16. The machine of claim 1, wherein said at least one surface is a carrier surface, said protective layer being held on said carrier surface through adhesive forces, said adhesive forces being one of a glue and mechanical tension forces.

17. The machine of claim 15, wherein said protective layer includes a plurality of protective layers including a top layer and other layers, said top layer being temporary and removable without causing damage to said other layers beneath said top layer, at least one of said other layers becoming a subsequent top layer when said top layer is removed.

18. The machine of claim 17, wherein said top layer is more flexible than said carrier surface.

19. A method for the treatment of a carrier surface in a machine for application of a coating medium onto a moving material web by way of at least one applicator device, comprising the step of applying a protective layer to the carrier surface during one of operation, start-up, slow-down and an exceptional operational condition of the machine, the carrier surface being exposable to at least one of the coating medium and contamination hazards.

20. The method of claim 19, further comprising the step of removing said protective layer together with said contamination and the coating medium adhering thereto, said protective layer having properties including anti-adhesive properties with regard to the coating medium and said contamination.

21. The method of claim 19, wherein said applying step includes one of spraying and steam-applying said protective layer on the carrier surface, said protective layer hardening thereon.

22. The method of claim 19, wherein said applying step includes gluing said protective layer onto the carrier surface.

23. The method of claim 19, wherein said applying step includes shrink-applying said protective layer onto the carrier surface.

24. The method of claim 19, wherein said applying step includes painting said protective layer on said carrier surface, said protective layer being one of a lacquer, a paint and a paste.

25. The method of claim 24, wherein said protective layer is applied to a thickness of from between approximately 40 μm to 200 μm.

26. The method of claim 24, further comprising the step of polishing said protective layer, after a drying time of between approximately 1 to 5 hours.

27. The method of claim 19, wherein said applying step includes applying a multi-layer protective layer including a top layer and other layers, said top layer being temporary and removable without causing damage to said other layers beneath said top layer, at least one of said other layers becoming a subsequent top layer when said top layer is removed.

28. A method for one of servicing and cleaning of a coater that applies a coating medium onto a moving material web using at least one applicator, comprising the steps of:
temporarily applying a protective layer to a carrier surface of the machine during one of operation, start-up, slow-down and an exceptional operational condition of the machine, said carrier surface being exposable to at least one of the coating medium and contamination hazards; and
removing said protective layer along with said contamination hazards and the coating medium adhered to said protective layer.

29. The method of claim 28, wherein said protective layer has an anti-adhesive property relative to said contamination hazards and to the coating medium.

30. The method of claim 28, further comprising the step of repeating said temporarily applying step and said removing step.

31. The method of claim 28, wherein said protective layer is renewable.

32. The method of claim 28, wherein said removing step includes utilizing at least one of a solvent and subjecting said protective layer to a predetermined temperature to remove said protective layer from said carrier surface.

33. The method of claim 28, wherein said temporarily applying step includes applying a multi-layer protective layer with said protective layer being defined as a top layer, said top layer being removable thereby positioning a subsequent layer of said multi-layer protective layer to become a subsequent protective layer.

34. A machine for one of production and converting of a material web, comprising:
a coating machine for the application of a coating medium onto a moving material web, said coating machine including:
at least one partial surface;
at least one applicator device; and
a protective medium being one of furnished and applied by at least one said applicator device to said at least one partial surface during one of operation, start-up, slow-down and an exceptional operational condition of the machine, said surface being exposable to at least one of said coating medium and contamination hazards, said protective medium forming a protective layer on said at least one partial surface, said protective layer being one of removable and continuously renewable during operation.

35. The machine of claim 34, wherein said protective layer is one of a liquid, very viscous and solidly non-rigid.

36. The machine of claim 34, wherein said protective layer is hydrophobic.

37. The machine of claim 34, wherein said protective layer has properties including at least one of being dirt repellent and being electrostatically repellent.

38. The machine of claim 34, wherein said at least one partial surface includes at least one of an internal carrier surface, an external carrier surface, an interior wall of a discharge opening of an applicator nozzle, an exterior wall of said discharge opening, guide surfaces, ink distributor pipes and an ink pan having said protective layer applied thereto.

39. The machine of claim 34, wherein said at least one partial surface includes at least one metallic surface.

40. The machine of claim 34, further comprising at least one of a film press, a coating unit having a long coating medium reaction time, a coating unit having a short coating medium reaction time, a coating unit with a pressure type open jet nozzle and a coating unit for curtain coating, having at least one surface equipped with said protective layer.

41. The machine of claim 34, wherein said protective layer is smoothly distributed on said at least one partial surface by one of spraying and steam-applying.

42. The machine of claim 34, further comprising spray nozzles mounted to the machine to apply said protective layer to said at least one partial surface.

43. The machine of claim 34, wherein said protective layer is painted onto said at least one partial surface.

44. The machine of claim 34, wherein said protective layer is one of oil based, grease based, wax based and paraffin based.

45. The machine of claim 34, wherein said protective layer is one of not removable and insignificantly removable by said coating medium.

46. The machine of claim 34, further comprising a treatment device delivering a solvent, said protective layer being removable by way of said solvent, said solvent not being contained in the coating medium.

47. The machine of claim 34, wherein said protective layer is removable from said at least one partial surface by subjecting said protective layer to a selected temperature.

48. The machine of claim 34, wherein said protective layer is a flowing barrier that keeps said contamination away from said at least one partial surface and transports said contamination away from said at least one partial surface.

49. The machine of claim 48, wherein said flowing barrier includes a solvent within which the coating medium is dissolvable.

50. The machine of claim 48, further comprising at least one of a spray pipe and a slotted nozzle delivering said flowing barrier, said flowing barrier being one of a liquid layer, a sheet-type liquid curtain and a water curtain.

51. The machine of claim 34, wherein said at least one partial surface includes a partial area thereon, said protective layer only covering said partial area.

52. The machine of claim 34, further comprising a work chamber substantially closed off to the outside, said protective layer being formed within said work chamber.

53. A method for the protection of a carrier surface in a coating machine for the application of a coating medium onto a moving material web, comprising the step of applying a protective layer to the carrier surface at least for the duration of an operation, said protective layer being formed by a protective medium that is supplied by an application device during one of operation, start-up, slow-down and an exceptional operational condition of the machine, the carrier surface being exposable to at least one of the coating medium and contamination hazards.

54. The method of claim 53, wherein said protective layer is smoothly distributed upon the carrier surface by one of spraying and steam-applying.

55. The method of claim 53, wherein said application device includes spray nozzles positioned to apply said protective layer to the carrier surface.

56. The method of claim 53, wherein said applying step includes painting said protective layer onto the carrier surface.

57. The method of claim 53, wherein said protective layer is not dissolvable by the coating medium.

58. The method of claim 53, wherein said protective layer is constantly renewed during operation of the coating machine.

59. The machine of claim 53, wherein said protective layer is a flowing barrier that keeps said contamination away from the carrier surface and transports said contamination away from the carrier surface.

60. The method of claim 58, wherein said protective layer includes a solvent within which the coating medium is dissolvable.

61. The method of claim 60, wherein said protective layer is a liquid.

62. The method of claim 61, wherein said liquid is water.

63. The method of claim 58, wherein said applying step includes producing said protective layer by way of at least one of a spray pipe and a slotted nozzle.

64. The method of claim 58, wherein said protective layer is formed on a partial area of the coating machine.

65. A method for one of servicing and cleaning a coating machine that applies a coating medium onto a moving material web, comprising the steps of:
one of removing a protective layer and constantly renewing said protective layer relative to at least one surface of the machine, the surfacing being protected by said protective layer from contamination, the surface being one of that is exposed and that could be exposed during one of operation, start-up, slow-down and exceptional operational conditions of the machine to the coating medium and is subjected to said contamination; and
forming said protective layer from a protective medium supplied to said at least one surface by way of a feed device.

66. The method of claim 65, wherein said protective layer is removed by application of a solvent, said solvent not being contained in the coating medium.

67. The method of claim 65, wherein said protective layer is removed by subjecting said protective layer to a temperature that does not normally occur in normal operation of the machine.

68. The method of claim 67, wherein said temperature is one of 60° above and 20° below said normal operation.

69. The method of claim 65, wherein said method steps are repeated.

70. A method for the treatment of surfaces in a machine for one of production and converting of a fibrous web, the surfaces being those that are in contact with a coating medium, the method comprising the step of furnishing the surfaces with a hydrophobic layer, said hydrophobic layer being a water repellent protective coating.

71. The method of claim 70, wherein said hydrophobic layer additionally possesses at least one of a dirt repellent and an electrostatic repellent characteristic.

72. The method of claim 70, wherein said protective coating is one of Teflon and fluorine containing paints.

73. The method of claim 72, wherein the surfaces includes at least one of an interior wall of a discharge opening of an applicator nozzle, an exterior wall of said discharge opening, guide surfaces, ink distributor pipes and an ink pan having said protective coating applied thereto.

74. The method of claim 72, wherein the surfaces are metallic surfaces to which the protective coating is applied.

75. The method of claim 72, wherein said protective coating has a thickness being from approximately 40 μm to 200 μm.

76. The method of claim 72, wherein said protective coating is polished after a drying time of approximately 1 to 5 hours.

77. The method of claim 70, wherein the machine includes at least one of a coater, a film press, a coating unit having a long coating medium reaction time, a coating unit having a short coating medium reaction time, a coating unit with a pressure type open nozzle jet and a coating unit for curtain coating, having at least one surface treated with said protective coating.
